(19) United States
(12) Patent Application Publication
(10) Pub. No.: US 2013/0131923 A1
(43) Pub. Date: May 23, 2013

(54) VEHICLE AND METHOD OF CONTROLLING THEREOF

(71) Applicant: Ofer TZIPMAN, Moshav Bitzaron (IL)

(72) Inventor: Ofer TZIPMAN, Moshav Bitzaron (IL)

(21) Appl. No.: 13/742,719

(22) Filed: Jan. 16, 2013

Related U.S. Application Data
(63) Continuation-in-part of application No. 13/001,842, filed on Dec. 29, 2010, now abandoned.
(60) Provisional application No. 61/077,187, filed on Jul. 1, 2008.

(51) Int. Cl. B62D 24/04

(52) U.S. Cl. CPC B62D 24/04
USPC 701/38; 280/124.103

(57) ABSTRACT

The vehicle that includes a primary chassis supported by a road; a secondary chassis adapted for supporting the driver and movably linked to the primary chassis; the secondary chassis being out of a mechanical contact to the road; and at least one mechanism adapted for controlling movement of the vehicle. The mechanism non-resiliently reacts to changing positions of the secondary chassis and the driver's body such that the driver is able to maintain resultant vector of forces applied to the secondary chassis directed to a point of a linkage between the primary chassis and the secondary chassis.

### REFERENCE TO RELATED APPLICATIONS

This application is a Continuation-in-Part of U.S. patent application Ser. No. 13/001,842, filed Dec. 29, 2010, which is a U.S. national phase entry of PCT/IL2009/000658 filed Jul. 1, 2009.

### FIELD OF THE INVENTION

The present invention generally pertains to a vehicle controlled by a driver, more specifically, a vehicle controlled according to an instantaneous position of a driver's body relative to the vehicle and relative position between vehicle's parts and according to a force applied to the vehicle, a driver and any part thereto.

### BACKGROUND OF THE INVENTION

Drive-by-wire (DbW) technology in the automotive industry replaces the traditional mechanical and hydraulic control systems with electronic control systems using electromechanical actuators and human-machine interfaces such as pedal and steering wheel emulators. Hence, the traditional components such as the steering column, intermediate shafts, pumps, hoses, fluids, belts, coolers and brake boosters and master cylinders are eliminated from the vehicle.

DbW technology has been hailed for liberating engineers to redesign the cabin, as well as for decreasing the risk of steering column related collision injury. It additionally allows for the steering human interface to take on unorthodox shapes and delivery methods. Still, for the most part the current DbW systems retain the traditional hand controlled steering interface familiar from conventional land and aviation vehicles.

Hand based steering human interfaces, and especially DbW ones, offer intuitive ease of use, however they can be challenging to the maintenance of balance of the vehicle and are notorious for not providing sufficient steering feedback. Furthermore, the driving experience they provide is largely a seated stationary one that may detract from the challenge of the driving experience.

It is therefore a long felt need to provide a human interface for a DbW steering system that offers increased balance as well a real sense of feedback to driver. Moreover, such an interface answers the desire for a fuller, more challenging driving experience.

### SUMMARY OF THE INVENTION

It is hence one object of the invention to disclose a vehicle controlled by a driver comprising: (a) a primary chassis supported by a road; (b) a secondary chassis adapted for supporting said driver and movably linked to said primary chassis; and (c) at least one mechanism adapted for controlling movement of said vehicle;

It is a core purpose of the invention to provide the mechanism non-resiliently reacting to changing positions of said secondary chassis and said driver's body such that the driver is able to maintain resultant vector of forces applied to said secondary chassis directed to a point of a linkage between the primary chassis and the secondary chassis, thereat a horizontal component of a linear displacement of the mass center belonging to the secondary chassis and driver is directed at the same direction as a horizontal component of the centripetal force, acceleration or deceleration forces.

It is another core purpose of the invention to provide the mechanism maintaining a resultant vector of forces applied to said secondary chassis directed to a point of a linkage between the primary chassis and the secondary chassis, thereat a horizontal component of a linear displacement of the mass center belonging to the secondary chassis and driver is directed at the same direction as a horizontal component of the centripetal force, acceleration or deceleration forces.

A further object of this disclosure is to disclose the secondary chassis displaceable by said driver.

A further object of this disclosure is to disclose the vehicle movement controlled in accordance with a position of said secondary chassis.

A further object of this disclosure is to disclose the vehicle comprising sensing means adapted for recognizing erratic vehicle movement and loss of vehicle grip in real time road conditions.

A further object of this disclosure is to disclose the controlling mechanism further comprising a steering unit. The vehicle is adapted for manually controlled steering in a manner separate from angular and linear displacement of said secondary chassis relative to said primary chassis.

A further object of this disclosure is to disclose a change in a instantaneous position characterized by angular and linear displacements of said driver body relative to said secondary chassis and said secondary chassis relative to said primary chassis.

A further object of this disclosure is to disclose the secondary chassis adapted for compensating longitudinal and lateral road grade due to tilting thereof relative to said primary chassis.

A further object of this disclosure is to disclose the secondary chassis further comprising stabilizing means. The aforesaid means is adapted for stabilizing said secondary chassis in a predetermined position.

A further object of this disclosure is to disclose the balance achieved by controlling a vehicle characteristic selected from the group consisting of changing driving direction, velocity, acceleration, deceleration, tilting said secondary chassis relative to said primary chassis, calibrating stabilized position of said secondary chassis and any combination thereof.

A further object of this disclosure is to disclose the vehicle further comprising computer means preprogrammed to control said mechanism to achieve said balance by controlling a vehicle characteristic selected from the group consisting of changing driving direction, velocity, acceleration, deceleration, tilting said secondary chassis relative_to said primary chassis, calibrating stabilized position of said secondary chassis and any combination thereof.

A further object of this disclosure is to disclose the computer means adapted for balancing said vehicle according to a force applied to said vehicle and a part thereof due to angular rotation of said secondary chassis about a longitudinal axis thereof and lateral linear shift relative to said primary chassis and changes in vehicle movement.

A further object of this disclosure is to disclose the computer means adapted for controlling movement of said vehicle according to a force applied to said vehicle and part thereof.

A further object of this disclosure is to disclose the vehicle further comprising computer means preprogrammed to control said stabilizing means so that secondary chassis is stabilized in an optimal calibrated position relative to said primary chassis; said optimal calibrated position provides balancing said vehicle and gripping said road depending on a momentary position of said driver.

### BRIEF DESCRIPTION OF THE FIGURES

In order to better understand the invention and its implementation in practice, a plurality of embodiments will now be described, by way of non-limiting example only, with reference to the accompanying drawings, wherein

FIGS. 1 to 4 are schematic views of a human interface for controlling movement of virtual and actual bodies;

FIGS. 5 and 6 are schematic diagrams of a spring linkage between primary and secondary chassis;

FIG. 7 is a schematic view of a human interface provided with wherein the longitudinally tiltable secondary chassis.

FIG. 8 is a schematic diagram of a rail-roller linkage between primary and secondary chassis;

FIGS. 9 and 10 are schematic diagrams of embodiments provided with motor-controlled positions of the secondary chassis relative the primary chassis and wheel angle, respectively; and

FIG. 11 is a schematic diagram of the computerized system.

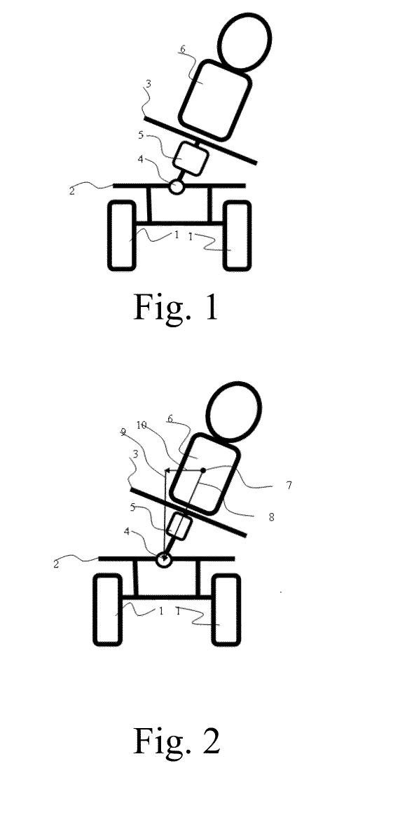

### DETAILED DESCRIPTION OF THE PREFERRED EMBODIMENTS

The following description is provided, alongside all chapters of the present invention, so as to enable any person skilled in the art to make use of said invention and set forth the best modes contemplated by the inventor of carrying out this invention. Various modifications, however, will remain apparent to those skilled in the art, since the generic principles of the present invention have been defined specifically to provide a human interface for controlling a vehicle.

The term “Drive-by-Wire (DbW)” refers hereinafter to a technology that replaces traditional mechanical and hydraulic control systems with electronic control systems using electromechanical actuators and human-machine interfaces such as pedal and steering wheel emulators.

The term “controlling” refers hereinafter to influencing the spatial direction or the velocity of a body.

The term “chassis” refers hereinafter to a primary platform, constructed in a manner selected from a group consisting of: continuous matter, interleaving matter, weaved material, composition of bars or pipes, or any combination thereof, to which a plurality of elements that comprise a moving body, such as a vehicle, are attached.

The term “point of linkage” refers hereinafter to a geometric center of the articulation between primary and secondary chassis.

The term “movement” refers hereinafter to any shift in the virtual or actual position of a body or parts thereof, including spatial shift, direction shift, facing direction shift, and velocity change.

The term “calibration” refers hereinafter to any readjustments to the data obtained from sensors or detectors, including complete disregard, in order to take into account environmental or other factors that would otherwise cause unintentional and undesired instructions to said controlling system.

The driver is tilted with his seat/harness and footrests according to the forces acting upon his body in order to balance some of them, especially gravity and centrifugal forces. All the suspensions and wheels (angles/geometry in relation to the road surface) may not be affected by the mentioned tilting. The center of gravity of the vehicle and the driver is not shifted towards the wheels bearing most of the load, and the load on the mentioned wheels is reduced while the load on the wheels bearing less load is increased, compared to the same vehicle had it not had the tilting capability.

Balancing the load over the wheels and suspensions provides better road grip and ride comfort due to better performance of the tires and suspensions not being overloaded/underloaded. The suspensions and wheels are not affected by the tilting result in optimal performance of the suspensions, tires and wheels. Tilting the driver's body results in better driving experience (similar to riding a bike) and driver's resistance to side forces for example (centrifugal force and acceleration/deceleration)

To assist in supporting the driver and secondary chassis in an upright or any other driver's desired position, a stabilizing system may be needed which may be provided by springs disposed between the two chassis adapted for supporting the secondary chassis in a predefined position. The driver can tilt the secondary chassis by changing his center of mass relative to the secondary chassis, or by counter steering. A gyro within the secondary chassis or a computer-controlled electro-mechanical system are also in the scope the current invention.

The present invention gives an opportunity of building vehicles that their driver will handle them in a similar manner to a motorbike being handled by its rider. In the same time it will give the vehicle designers the freedom of designing vehicles with three, four or more wheels or skis for example and maybe also with less than that, vehicles that their suspensions' configuration and wheels' geometry may remain optimal and not be necessarily affected by the driver's position or the wheels pointing direction or any other irrelevant parameter (like it is with the Yamaha Tesseract for example). The suspensions' configuration and wheels' geometry may be designed in a similar manner to car's suspensions and wheels, for example. This is achieved by separating, as much as possible, the movement of the chassis carrying all the suspensions, wheels or skis from the movement of the chassis carrying the driver, in a manner such that pitch, yaw or roll of one chassis has a minimal effect over the other chassis. At the same time a horizontal vector of the center of mass of the secondary chassis and driver moves in the same direction of the horizontal vector of the centripetal force, acceleration or deceleration forces. This contributes to less rolling torque acting upon the vehicle compared to the same vehicle had it had no tilting capabilities.

So the 3 main principles of the invention are:

1. Separating, the movement of the chassis carrying all the suspensions, wheels or skis from the movement of the chassis carrying the driver.

2. The horizontal component of a linear displacement of the mass center belonging to the secondary chassis and driver is directed at the same direction as a horizontal component of the centripetal force, acceleration or deceleration forces.

3. The resultant force of gravity and centrifugal force, should be pointed to a linkage point of the primary chassis and secondary chassis. When the driver is properly harnessed (seated) in his harness (seat), he should feel no side forces and no front or back forces acting upon his body.

When riding a bike, the gyro effect of the wheels, for example, assists the rider in maintaining balance. A purpose of the present invention is to assist the driver in maintaining desired position in an environment of constantly changing forces like gravity, centrifugal force, acceleration and deceleration acting upon him and the vehicle.

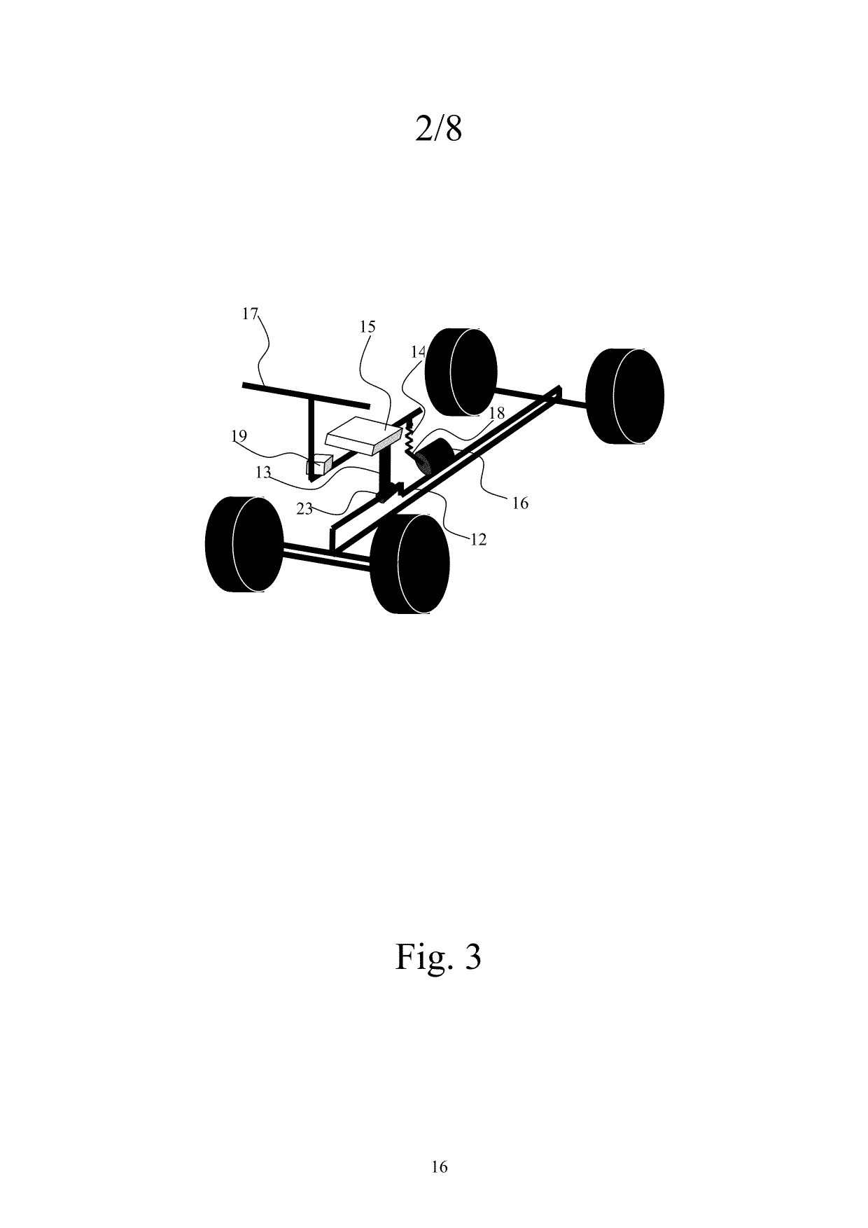

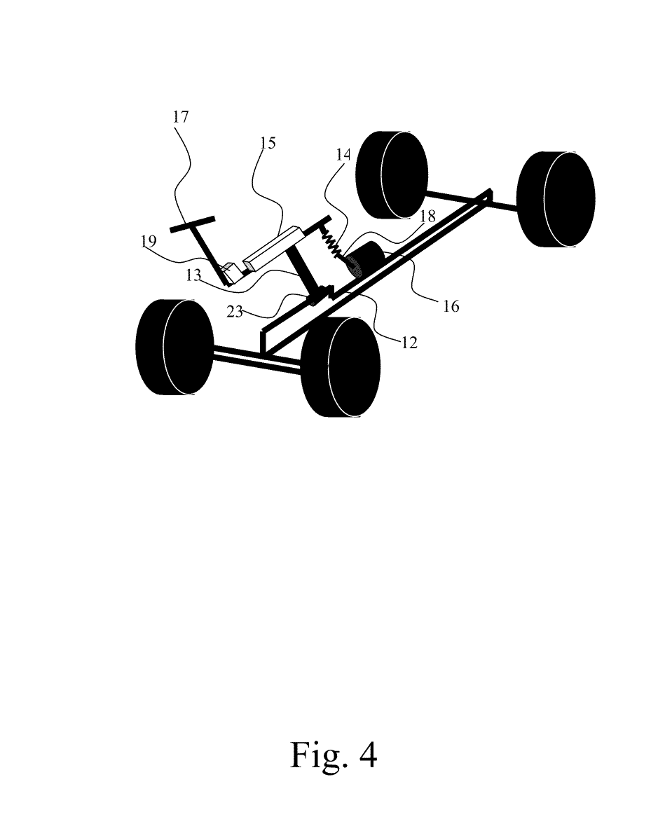

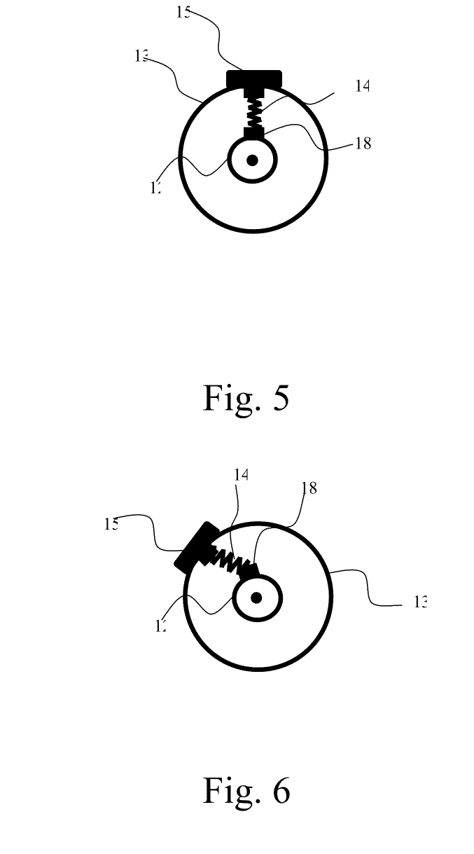

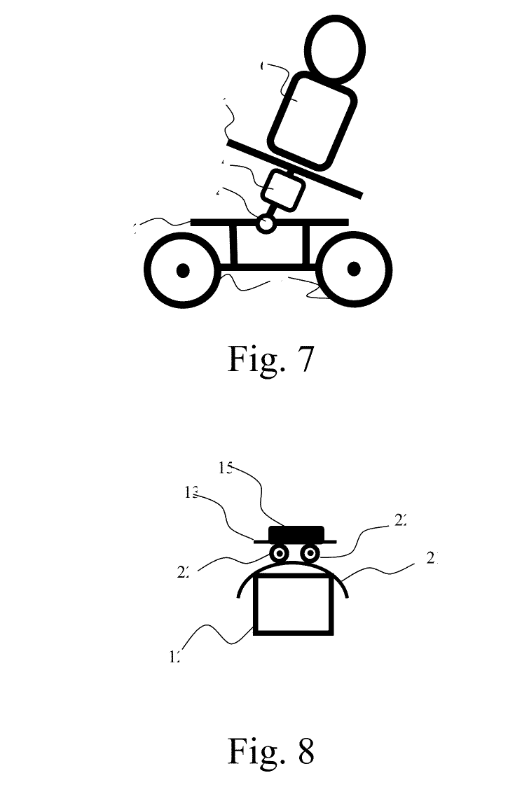

FIGS. 3-6 depict an alternative embodiment of the present invention, where a spring 14 interconnects the primary chassis 12 and the secondary chassis 13 which is able to rotate around the primary chassis 12. The secondary chassis is provided with seat 15. The spring is configured such that only one point (henceforth an optimal point), in the course of the secondary chassis around the primary chassis, has the shortest distance between the two ends of the spring (shown in FIG. 4 and FIG. 5). Any other point on the course (shown in FIG. 3 and FIG. 6) results in force applied to the chassis trying to drive them towards the optimal point. The end of the spring located on the primary chassis is connected on a jag 18 on an electric motor shaft. The electric motor 16 controls the position of the jag 18, hence the spot where the shortest path between the ends of the spring 14 i.e. the optimal point. The electric motor 16 is controlled by a computer (not shown) that calculates the whereabouts of the optimal point. The computer decisions are based on sensors reading. An accelerometer 19 placed on the secondary chassis 13 measures the resultant force of gravity, centrifugal force, acceleration and deceleration. If the sensor reading shows that the resultant force not pointing towards the center of the joint between the primary chassis and the secondary chassis, then the computer turns the shaft in a way that creates force that assists the secondary chassis in moving to a position (the new optimal point) where the resultant force measured by the sensor points again to center of the joint. For example if the resultant force points left of the center of the joint, the shaft shall rotate to the right creating a force on the secondary chassis to rotate to right and if the secondary chassis does rotate to the right then the resultant force should point more to the right.

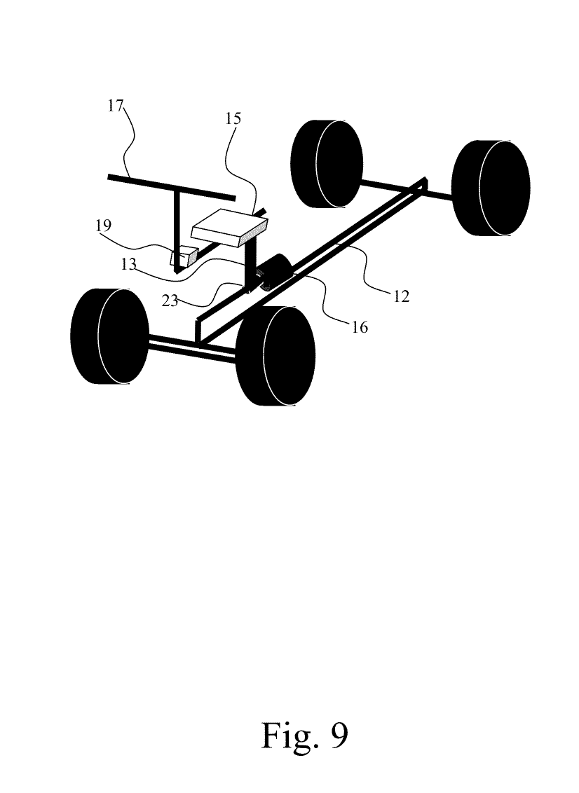

FIG. 9 depicts an embodiment wherein the tilt angle is based on readings from an accelerometer 19. When the accelerometer reading indicates that the resultant force is not oriented onto the joint 23 interconnecting the primary chassis 12 and the secondary chassis 13, the electric motor 16 changes the tilt angle between the secondary chassis 13 and the primary chassis 12 and orients the resultant force to point to the joint. For example, if the sensed resultant force points left to the joint, then the electric motor tilt the secondary chassis to the right thus making the resultant force point more to the right.

FIG. 8 depicts a driver's seat 15 located on the secondary chassis 13. Rollers 22 are placed within/on top of rail(s) 21 which is attached to the primary chassis 12. A curvature of the rail 21 defines a slant angle of the seat on every point along the rail. In this specific embodiment where a perpendicular to the seat surface is directed to a center of rail symmetry is considered as the above-mentioned point of the linkage.

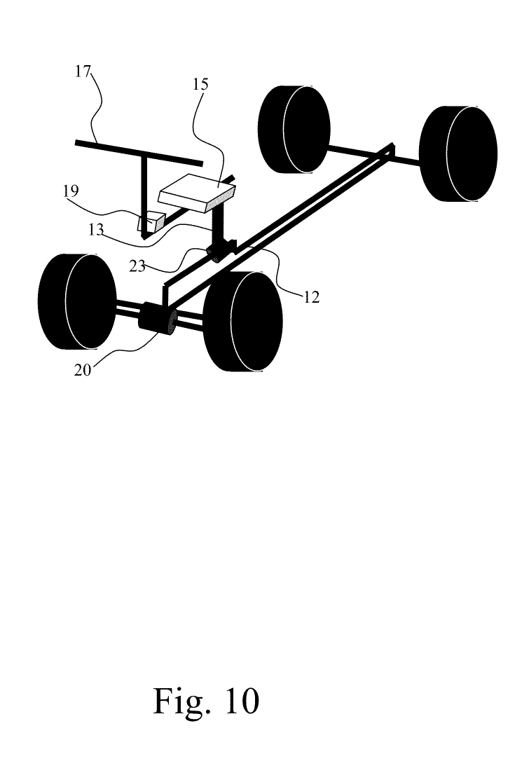

FIG. 10 depicts an embodiment wherein the front wheels angle is based on readings from an accelerometer 19. When the accelerometer reading indicates that the resultant force not pointing the joint 23 (point of linkage) between the primary chassis 12 and the secondary chassis 13, electric motor 20 changes the direction of swivel wheels and thus orients the resultant force to the joint. For example, if the sensed resultant force points left to the joint, then the electric motor turns the wheels to the left thus making the resultant force point more to the right by changing the centrifugal force more to the right. Changing the tilt angle will also change the gravity vector on the resultant force.

An algorithm of imbalance detection is as follows. According to the present invention, the angle and rate in which the driver (secondary chassis) should be displaced/tilted is once again determined by the mechanism. A purpose of the action taken by the mechanism is to configure the stabilizing means in order to support the secondary chassis (driver) in the optimal position (as calculated by the mechanism) relative to the primary chassis.

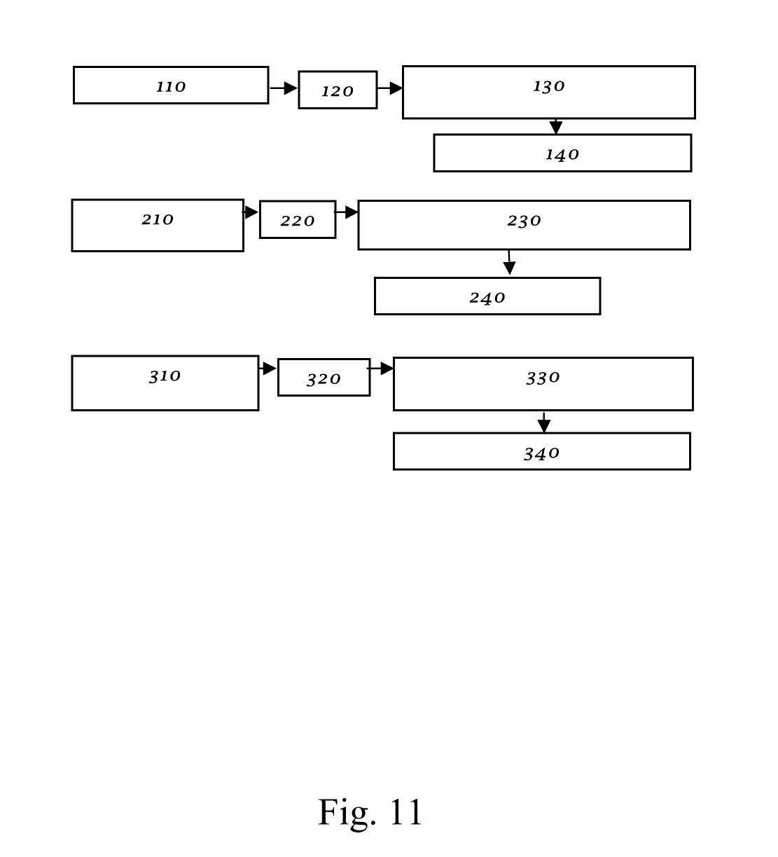

FIG. 11 depicts a computerized system of the present invention. A force sensor(s) 110/210/310 is configured for sensing out-of-balance condition of the secondary chassis. The aforesaid condition can be indicated by measuring a side/front/back force applied to the secondary chassis. The microcontroller units (MCU) 120, 220 and 320 receive signals from the sensor 110/210/310 and initiate a preprogrammed action of actuators 130, 230 and 330. Specifically the MCU 120 controls an actuator 130 which is mechanically connected to a stabilizing mechanism. The actuator 130 configures the stabilizing mechanism to support the secondary chassis in a spot/manner that should assist the driver to keep the secondary chassis position where the forces applied to the secondary chassis are balanced. A direction and velocity control mechanism 240 is actuated by an actuator 230 controlled by MCU 220. The actuator 230 causes the wheels to turn into a direction that should restore balance/minimize the effect of forces. The actuator 230 causes acceleration/deceleration of the vehicle in a manner that should restore balance/minimize the effect of forces. A secondary chassis control mechanism 340 is actuated by the actuator 330 which causes the secondary chassis to tilt to the sides/backward/forward in a manner to restore balance/minimize the effect of forces.

Modified systems of the above embodiments may also learn about the driver's will to tilt or to change the vehicle's direction or velocity, by sensors located for example in the driver's harness or seat or through the handlebar. The systems may then tilt the secondary chassis or assist in tilting the secondary chassis, or change the vehicle's direction or velocity. For example: a situation where the secondary chassis is balanced and the system senses that the driver wants to tilt left then the system would tilt the secondary chassis left using an electric motor for example (FIG. 9) and that would put the secondary chassis out of balance and the driver should then point the wheels left in order to have gravity and the centrifugal force assist in balancing the forces on the secondary chassis.

According to the one embodiment of the present invention, a system that controls a tilt angle and a direction of the wheels in a situation when the secondary chassis is balanced and the system senses, by sensors in the seat, that the driver wants to tilt left, then the system would tilt the secondary chassis left and that would put the secondary chassis out of balance then the system would point the wheels left in order to have gravity and the centrifugal force assist in balancing the forces on the secondary chassis.

The erratic vehicle movement is defined as a movement that occurs from forces other than gravity, centrifugal force, intended acceleration, intended deceleration and affects the chassis of the vehicle. These forces may result by bumpy road, winds, engine vibrations, etc. These forces may be sensed by accelerometer (or gyro) for example, especially if it is used in implementation to sense gravity, centrifugal force, acceleration or deceleration. The mechanism should regulate its actions taking into account that the sensed signals may be noise and should not affect the actions taken by the mechanism. Another option is that the sensed signals indicate abnormal event, for example loss of grip. In that case the mechanism may take actions like changing the tilt angle of the driver or changing the steering wheels' angle or changing velocity.

In specific implementations of the mechanism, trying to guess the forces according to the steering angle and the angle between the primary and secondary chassis, as well as velocity of the vehicle for example, if the mechanism ignores the angle between the primary chassis and an imaginary leveled surface (represents the direction of the gravity force), errors may occur due to the mechanism's failure to know the angle of the driver compared to the above imaginary leveled surface and thus the direction of the gravity force (as well as centrifugal force, acceleration and deceleration). A remedy to the described problem may be a sensor (e.g. gyro), located in the primary chassis, that may tell the angle between the primary chassis and the above imaginary leveled surface.

Example: The forces measured upon the secondary chassis represent the forces measured upon the driver. The vehicle is balanced when the resulting force (result of gravity, centrifugal force, acceleration, and deceleration) is pointing from the seat on the secondary chassis towards a real/imaginary joint of the secondary chassis and the primary chassis (point of linkage). If the driver shifts his center of mass and moves the secondary chassis out of balance, an accelerometer senses that the resulting force has changed. The computer reads the accelerometer and the reading shows the resulting force is different than a pre-calibrated force representing a balanced vehicle. The computer controls the movement of the vehicle by controlling the steering wheels, acceleration or deceleration. The computer changes the vehicle movement in order to apply a force to the vehicle in order to restore balance.

1. A vehicle controlled by a driver comprising:
(a) a primary chassis supported by a road;
(b) a secondary chassis adapted for supporting said driver and movably linked to said primary chassis; said secondary chassis being out of a mechanical contact to said road;
(c) at least one mechanism adapted for controlling movement of said vehicle;
wherein said mechanism non-resiliently reacts to changing positions of said secondary chassis and said driver's body such that the driver is able to maintain resultant vector of forces applied to said secondary chassis directed to a point of a linkage between the primary chassis and the secondary chassis, thereat a horizontal component of a linear displacement of the mass center belonging to the secondary chassis and driver is directed at the same direction as a horizontal component of the centripetal force, acceleration or deceleration forces.

2. A vehicle controlled by a driver comprising:
(a) a primary chassis supported by a road;
(b) a secondary chassis adapted for supporting said driver and movably linked to said primary chassis; said secondary chassis being out of a mechanical contact to said road;
(c) at least one mechanism adapted for controlling movement of said vehicle;
wherein said mechanism maintains a resultant vector of forces applied to said secondary chassis directed to a point of a linkage between the primary chassis and the secondary chassis, thereat a horizontal component of a linear displacement of the mass center belonging to the secondary chassis and driver is directed at the same direction as a horizontal component of the centripetal force, acceleration or deceleration forces.

3. The vehicle according to claim 1 or 2, wherein said secondary chassis is displaceable by said driver.

4. The vehicle according to claim 1 or 2, wherein said vehicle movement is controlled in accordance with a position of said secondary chassis.

5. The vehicle according to claim 1 or 2 comprising sensing means adapted for recognizing erratic vehicle movement and loss of vehicle grip in real time road conditions.

6. The vehicle according to claim 1 or 2, wherein said controlling mechanism further comprises a steering unit; said vehicle is adapted for manually controlled steering in a manner separate from angular and linear displacement of said secondary chassis relative to said primary chassis.

7. The vehicle according to claim 1 or 2, wherein a change in an instantaneous position is characterized by angular and linear displacements of said driver body relative to said secondary chassis and said secondary chassis relative to said primary chassis.

8. The vehicle according to claim 1 or 2, wherein said secondary chassis is adapted for compensating longitudinal and lateral road grade due to tilting thereof relative to said primary chassis.

9. The vehicle according to claim 1 or 2, wherein said secondary chassis further comprises stabilizing means; said means is adapted for stabilizing said secondary chassis in a predetermined position.

10. The vehicle according to claim 1 or 2, wherein a balance of forces applied to said secondary chassis is achieved by controlling a vehicle characteristic selected from the group consisting of changing driving direction, velocity, acceleration, deceleration, tilting said secondary chassis relative to said primary chassis, calibrating stabilized position of said secondary chassis and any combination thereof

11. The vehicle according to claim 1 or 2, further comprising computer means preprogrammed to control said mechanism to achieve said balance by controlling a vehicle characteristic selected from the group consisting of changing driving direction, velocity, acceleration, deceleration, tilting said secondary chassis relative to said primary chassis, calibrating stabilized position of said secondary chassis and any combination thereof.

12. The vehicle according to claim 11 wherein said computer means is adapted for balancing said vehicle according to a force applied to said vehicle and a part thereof due to angular rotation of said secondary chassis about a longitudinal axis thereof and lateral linear shift relative to said primary chassis and changes in vehicle movement.

13. The vehicle according to claim 11, wherein said computer means is adapted for controlling movement of said vehicle according to a force applied to said vehicle and part thereof.

14. The vehicle according to claim 9, further comprising computer means preprogrammed to control said stabilizing means so that secondary chassis is stabilized in an optimal calibrated position relative to said primary chassis; said optimal calibrated position provides balancing said vehicle and gripping said road depending on a momentary position of said driver.

15. The vehicle according to claim 1 or 2, wherein a linkage is adapted for fixating said primary and secondary chassis in a predetermined relative position.

16. The vehicle according to claims 9, wherein said stabilizing means is selected from a group consisting of gyro, real-time adjustable springs or elastic objects, fluid cylinders, friction devices, magnetic components and any combination thereof

17. The vehicle according to claim 1 or 2, wherein said forces are selected from the group consisting of gravity, centrifugal force, acceleration, deceleration, and any combination thereof.
